(19) United States
(12) Patent Application Publication
(10) Pub. No.: US 2016/0283993 A1
(43) Pub. Date: Sep. 29, 2016

(54) COMPUTING APPARATUS AND METHOD FOR INTERMEDIATING INTERACTIONS BETWEEN COMPUTING DEVICES

(71) Applicant: Intel Corporation, Santa Clara, CA (US)

(72) Inventor: Rita H. Wouhaybi, Portland, OR (US)

(21) Appl. No.: 14/668,417

(22) Filed: Mar. 25, 2015

(51) Int. Cl. G06Q 30/06

(52) U.S. Cl. CPC G06Q 30/0605; G06Q 30/0613; G06Q 30/0637

(57) ABSTRACT

The present disclosure describes embodiments of apparatuses and methods for intermediating interactions between computing devices. In embodiments, an apparatus may receive data sets associated with seller and consumer computing devices and process the data sets to identify a transaction match. The apparatus may transmit the transaction matches to two or more consumer devices associated with the matches. The apparatus may engage in a purchase transaction with a seller computing device on behalf of the consumer devices associated with the match. Other embodiments may be disclosed and/or claimed herein.

### FIELD

Embodiments of the present disclosure generally relate to the field of systems and methods for intermediating interactions between computing devices.

### BACKGROUND

Sellers of products often provide volume purchase incentives to increase sales of selected products. These incentives may be in the form of buy one and get one free or buy one and get one at 50%, or the like. In addition, some sellers may offer volume discounts on a large quantity of a selected product. Volume discounts may be offered by warehouse type sellers. Often, a consumer does not need more than one of a particular item, or a consumer does not need a large quantity associated with a particular volume discount. Under the present art, consumer computing devices and seller computing devices are not able to interact with each other in a manner that enables a consumer with less needs to take advantage of such incentives or volume discounts, unless the consumer buys more than the consumer needs.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a computing apparatus in a system for intermediating interactions between computing devices for a volume or discount purchase transaction between at least one seller computing device and at least two consumer computing devices, in accordance with some embodiments.

FIG. 2 schematically illustrates a computing apparatus for intermediating interactions between computing devices for an online purchase transaction, in accordance with some embodiments.

FIG. 3 schematically illustrates a method for intermediating interactions between computing devices for an online purchase transaction, in accordance with some embodiments.

FIG. 4 schematically illustrates a non-transitory computer readable storage medium with programming instructions to cause a computing apparatus, in response to execution of the instructions by a processor of the computing apparatus, to practice aspects of embodiments of the processes for intermediating interactions between computing devices for an online purchase transaction as disclosed herein, in accordance with some embodiments.

FIG. 5 schematically illustrates a computing apparatus for intermediating interactions between computing devices for a purchase transaction, in accordance with some embodiments.

FIG. 6 schematically illustrates a method for intermediating interactions between computing devices for a purchase transaction, in accordance with some embodiments.

FIG. 7 schematically illustrates a non-transitory computer readable storage medium with programming instructions to cause a digital content consumption device, in response to execution of the instructions by a processor of the digital content consumption device, to practice aspects of embodiments of the processes for intermediating interactions between computing devices for a purchase transaction as disclosed herein, in accordance with some embodiments.

### DETAILED DESCRIPTION

Embodiments of the present disclosure describe apparatuses and methods for intermediating interactions between consumer computing devices and seller computing devices, and associated techniques and configurations. In the following description, various aspects of the illustrative implementations are described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical and/or electrical contact. However, “coupled” also may mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” by one or more network linkages.

In various embodiments, the phrase “a first feature formed, deposited, or otherwise disposed on a second feature” may mean that the first feature is formed, deposited, or disposed over the second feature, and at least a part of the first feature may be in direct contact (e.g., direct physical and/or electrical contact) or indirect contact (e.g., having one or more other features between the first feature and the second feature) with at least a part of the second feature.

As used herein, the term “module” may refer to, be part of, or include an Application Specific Integrated Circuit (ASIC), an electronic circuit, a system-on-chip (SoC), a processor (shared, dedicated, or group), and/or memory (shared, dedicated, or group) that execute one or more software or firmware programs, a combinational logic circuit, and/or other suitable components that provide the described functionality.

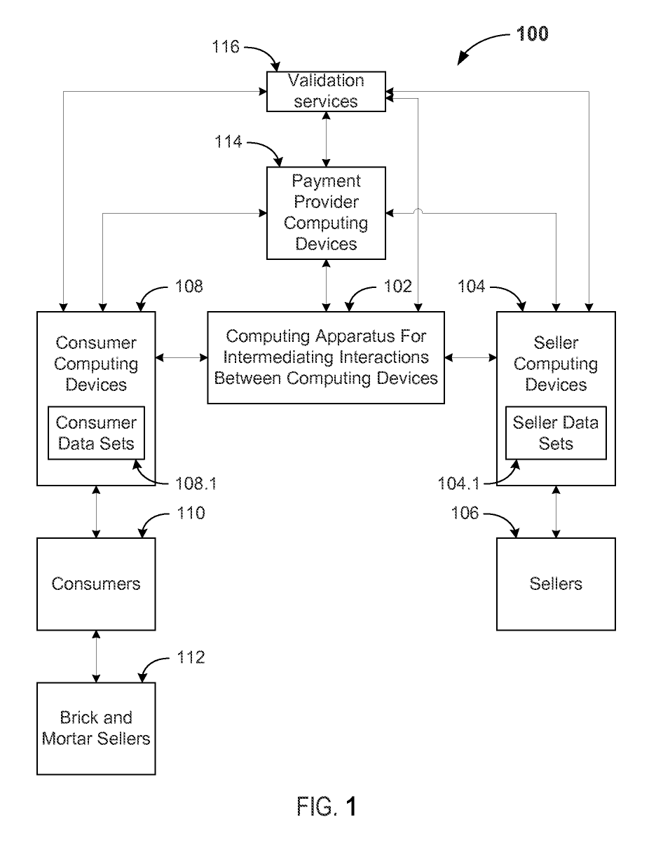

FIG. 1 schematically illustrates a computing apparatus 102 in a system 100 for intermediating interactions between computing devices 104, 108 for a volume or discount purchase transaction between at least one seller computing device 104 and at least two consumer computing devices 108, in accordance with some embodiments. As illustrated, in some embodiments, the computing apparatus 102 of system 100 may be linked over a network to one or more seller computing devices 104 and one or more consumer computing devices 108. The computing apparatus 102 may have two way communications with the seller computing devices 104 and the consumer computing devices 108. The seller computing devices may have seller data sets 104.1 associated with the seller computing devices 104. The seller data sets 104.1 may be provided by the seller computing devices 104 and/or may be provided by a search of the Internet using an algorithm (not shown) by the computing apparatus 102. Seller computing devices 104 may be associated with sellers 106. The seller data sets 104.1 may include product category data and discount and/or volume data. The product category data may include product manufacturer, product brand, product trademark, and/or product model number. The discount and/or volume data may include, but are not limited to, buy one get one free, buy two get one at a certain percentage off, buy a certain volume at a reduced price per unit in the volume, or the like. The consumer computing devices 108 may have consumer data sets 108.1 associated with the consumer computing devices 108. Data in the consumer data sets may be transmitted by the consumer computing devices and/or may be obtained by the computing apparatus 102 by a query of the consumer computing devices 108 or may be obtained by query of stored search results and/or browsing history on a server, where the search results and/or browsing history may be associated with the consumer computing device 108 or a consumer using the consumer 110 computing device 108. The consumer data sets 108.1 may include the product category data, the discount and/or volume data, which may be in the form of threshold levels of discounts and/or volume pricing, a purchase date or date range, a particular seller, and a preferred payment method. The computing apparatus 102 may process consumer data sets 108.1 and seller data sets 104.1 to identify one or more transaction matches between two or more consumer computing devices 108 and at least one seller computing device 104. The computing apparatus 102 may proceed with a purchase transaction with the at least one seller on behalf of the two or more consumer computing devices. The at least one seller may ship one or more products to consumers 110 associated with the consumer computing devices 108 or may hold the products for pickup by the consumers 110 associated with the consumer computing devices 108. The computing apparatus 102 may perform the purchase transaction with the seller computing devices 104 as a virtual consumer computing device, where the virtual consumer computing device includes the consumer computing devices 108 that may be associated with the transaction matches. The consumers 110 may have direct contact with brick and mortar sellers 112. After computing apparatus 102 has identified a purchase transaction match, according to embodiments disclosed herein, between two or more consumers by processing the consumer data sets 108.1, the computing apparatus 102 may transmit the purchase transaction match to the consumer computing devices 108 associated with the purchase transaction match. At least one of the consumers 110 associated with the consumer computing devices 108 may be designated the as a buying consumer 110 and may make a purchase at a brick and mortar seller 112. At least one of the consumers 110 may be designated as non-buyer consumer 110 and may take possession of a portion of the item/items purchased by the buying consumer in an agreed upon exchange method transmitted to the consumer computing devices associated with the respective buyer and non-buyer consumers 110. The computing apparatus 102, the consumer computing devices 108, and the seller computing devices 106 may be linked over the network to payment provider computing devices 114, which may include devices associated with service providers such as banks, credit unions, credit card companies, and online account service providers such as PayPal. The computing apparatus 102, the consumer computing devices 108, and the seller computing devices 106 may be linked over the network to one or more validation services (credit agencies or better business bureaus) 116 in order to validate the credit worthiness of one or more consumers or the business practices of one or more sellers. Payment provider computing devices 114 may be linked over the network to the validation services 116.

In some embodiments, the consumers associated with consumer computing devices 108 may be complete strangers to each other. In some embodiments, the consumer purchase preferences may include an indication of the level of interest in partnering to take advantage of buy one get one free (BOGO) type sales or volume discounts. In some embodiments, consumers may take advantage of a BOGO type sale without having to buy more than needed. In some embodiments, the consumer data sets 108.1 may be based on implicit and explicit input and may be used by the computer apparatus 102 to match make consumer data sets 108.1 of difference consumer computing devices 108. The computing apparatus 102 may provide an option of a middleman to keep the identity of the users completely anonymous, even though that might create an overhead which will take away from the savings. The computing apparatus 102 may support multiple payment options from payment providers 114, and may offer a transparent service payment service. In some embodiments, the computing apparatus 102 may be a rendezvous apparatus among strangers facilitate transactions. The players in the system may be described as: consumers interested in buying. In some embodiments, the consumers associated with consumer computing devices may indicate a level of interest in buying an item. In some embodiments, a level of interest may be obtained by a consumer computing device 108 scanning a barcode of the item. In some embodiments, a consumer 110 may identify the quantity of an item the consumer 110 of interest in purchasing. In some embodiments, the quantity may be expressed Buy 2 get 2 free, or the like. In some embodiments, a consumer 110 may identify a preferred method of payment, which may include credit card, debit card, gift card, cash, PayPal, bitcoin, coupons, or a combination thereof. In some embodiments, a consumer 110 may identify one or more discounts the consumer is willing to share with other consumers through the consumer computing devices. By way of example and not limitation, some consumers 110 may have additional coupons that the consumers 110 are willing to offer other consumers 110. By way of example and not limitation, some consumers 110 may have a seller card that will offer additional money off or cashback, such as an additional 5% any purchase. In some embodiments, consumers 110 may indicate a level of interest in willingness to perform a purchase transaction as a buyer consumer and get reimbursed by a non-buyer consumer through the computing apparatus 102. In some embodiments, consumers 110 may indicate a current location. In some embodiments, consumers 110 may indicate an expected time to purchase a item. By way of example and not limitation, some consumers 110 may be in a seller brick and mortar store 112, and may be interested in partnering with another consumer 110 via the consumer computing devices being matched through the computing apparatus 102 as long as the purchase happens while the consumer 110 is in the store.

In some embodiments, the computing apparatus 102 may attempt to minimize risk of a fraudulent transaction between consumers 110 via consumer computing devices 108. In some embodiments, the consumer computing devices 108 may be associated with accounts in the computing apparatus 102. In some embodiments, the account s may be linked with at least one method of payment such as credit card, debit card, PayPal account, or bitcoin account. In some embodiments, the buyer consumer and the non-buyer consumer do not need to be in the brick and mortar seller store for a purchase transaction. In some embodiments, payment for a product is made by a buyer consumer 110 through the computing apparatus 102 or through the consumer computing device associated with the buyer consumer 110. In some embodiments, the non-buyer consumer 110 may pay an agreed to amount for a product through the computing apparatus 102 or through a consumer computing device associated with the non-buyer consumer 110. In some embodiments, the non-buyer may make a payment or has an amount placed in escrow or on hold in an account of the computing apparatus 102 before the buyer consumer 110 purchases the product. By way of example and not limitation, a non-buyer consumer 110 may provide a consumer data set with data that indicates an interest in a sale on a Sunday Morning. Two days later, buyer consumer 110 may be at a brick and mortar seller store 112 and be match by the computing apparatus 102 with the non-buyer consumer 110 and perform the purchase transaction. The buyer consumer 110 may be driving close to the non-buyer consumer's location and the matching algorithm of computing apparatus 102 provides an exchange of the product at a local café. An amount of money may be transferred by computing apparatus 102 from non-buyer's consumer account to buyer's consumer account while computing apparatus may place a hold, equal to the amount transferred, on buyer's consumer account to provide incentive for non-buyer consumer 110 to meet with buyer consumer 110 to obtain the product and incentive for buyer consumer 110 to make the purchase transaction. The buyer consumer 110 may have incentive to meet with the non-buyer consumer 110 because the buyer consumer 110 has paid full price for the product and would like to recover part of the amount paid for an additional item as a part of a BOGO type purchase. In some embodiments, the computing apparatus 102 may have received a reputation score, where the score indicates a level of honesty and a level of promptness for the consumers 110. The score may reflect how well consumers 110 handle the additional item(s) delivered to other consumers.

In some embodiments, a consumer 110 may input a consumer data set 108.1 into a consumer computing device 108, and the computing apparatus 102 may receive the consumer data set 108.1 and process the data set to identify one or more matches with other consumer data sets. In some embodiments, the computing apparatus may make a match with another consumer data set based on: same sale, same store, and same price matching. In some embodiments, the matches may be transmitted by the computing apparatus and received by the consumer computing devices. In some embodiments, a reputation score may be transmitted by computing apparatus 102 and received by consumer computing device 108. In some embodiments, the computing apparatus 102 may transmit rank matches according to reputation score, proximity, and/or what other incentives contained and available in a consumer data set of a matched consumer computing device. In some embodiments, when computing apparatus 102 does not identify matches, computing apparatus 102 may transmit to consumer computing devices associated with consumers in a social network of the consumer 110, in order to further identify consumers associated with consumer computing devices 108 that have matching consumer data sets or even to other parties who are identified as potential interested parties. In some embodiments, the computing apparatus 108 may transmit seller data sets and may not transmit data identifying other consumers 110 with matching consumer data sets 108.1. In some embodiments, computing apparatus 102 may process consumer data sets containing data about consumers in a brick and mortar seller store 112 or consumer data sets containing data about consumers indicating an interest in online transaction, intermediated by computing apparatus 102.

In some embodiments, the computing apparatus 102 may obtain transaction matches of consumer data sets 108.1 associated with consumer computing devices 108 and make a purchase with seller computing devices 104 on behalf of the consumer computing devices 108, as a virtual consumer computing device, where the item is shipped to a physical location associated with one of the consumers 110 associated with the consumer computing devices 108. In some embodiments, computing apparatus 102 may process consumer data sets 108.1 and transmit transaction matches to consumer computing devices associated with the matching consumer data sets, where the consumers associated with the consumer computing devices meet in a brick and mortar store and perform the transaction in the store by each paying the amount in the transaction match.

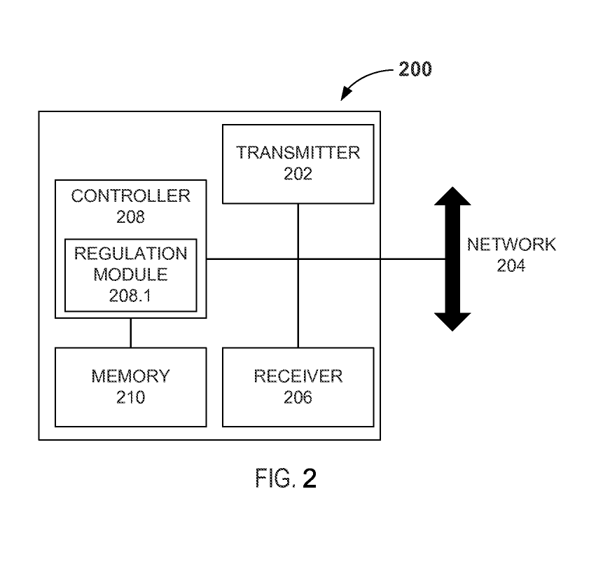

FIG. 2 schematically illustrates a computing apparatus 200 for intermediating interactions between computing devices for an online purchase transaction, in accordance with some embodiments. In some embodiments, the computing apparatus 200 may include a receiver 206 to receive over a network 204 a plurality of seller data sets that include a product category and a discount, the seller data sets associated with seller computing devices, and a plurality of consumer data sets associated with consumer computing devices and include consumer purchase preferences, a controller 208 coupled to the receiver 206 and a transmitter 202, the controller 208 with a regulation module 208.1 to process the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets, wherein the controller 208 may regulate the transmitter 202 and receiver 206 to engage in a purchase transaction over the network to purchase one or more products associated with the transaction matches, the purchase transaction is with the seller computing devices associated with the transaction matches and is on behalf of the one or more consumer device groups, as a virtual consumer device. The controller 208 may be coupled to a memory 210 of the apparatus 200. The controller 208 may store in the memory 210 the seller and consumer data sets. The data sets may be associated with seller and consumer accounts, respectively. The consumer accounts may include an account balance. In some embodiments, the transmitter 202 may be coupled to a second computing apparatus, wherein the second computing apparatus may be coupled to the computing apparatus 200. In some embodiments, the consumer purchase preferences may include the product category, the discount, a purchase date, a seller, and a payment method, wherein the transaction matches may be identified when the product category matches and the discount matches among two or more consumer computing devices and at least one of the seller devices and the purchase date overlaps, the seller matches, and the payment method matches between the two or more consumer computing devices. In some embodiments, the consumer device groups may be determined by the controller 208 when, for two or more consumer purchase preferences associated with two or more consumer devices: the product category matches completely or partially; the discount match may be the same or within a set range of overlap or no discount threshold is set; the purchase date may be the same, overlap, within a certain number of days apart, or no purchase date is set; the seller may be the same or the same type of seller or no seller is specified; and the payment method may match exactly or the same type of payment method or no payment method is specified. In some embodiments, the transaction matches may be identified when a consumer device group matches with the product category of a seller. In some embodiments, a product category match may include a match of product manufacturer, product brand name, product trademark, and/or product model number, and various combinations of the foregoing. A product model number may be expressed as a size or some dimension without an actual model number. By way of example and not limitation, a product category match may be “tissue,” without a brand name or trademark. By way of example and not limitation, a product category match may be a Sony smart television with a screen size between 40 and 55 inches. By way of example and not limitation, the discount match may be an exact match such as buy one get one 40% off. By way of example and not limitation, the discount match may be one consumer preference specifying a volume of an item at $20 dollars or less and another consumer preference specifying a volume of the same item at $25 dollars or less, where a seller is selling the volume of the item at $19.95. In some embodiments, the controller 208 may regulate the transmitter 202 to transmit over the network 204 a request for transaction authorization to the consumer computing devices and to regulate the receiver 206 to receive over the network 204 a transaction authorization from the consumer computing devices.

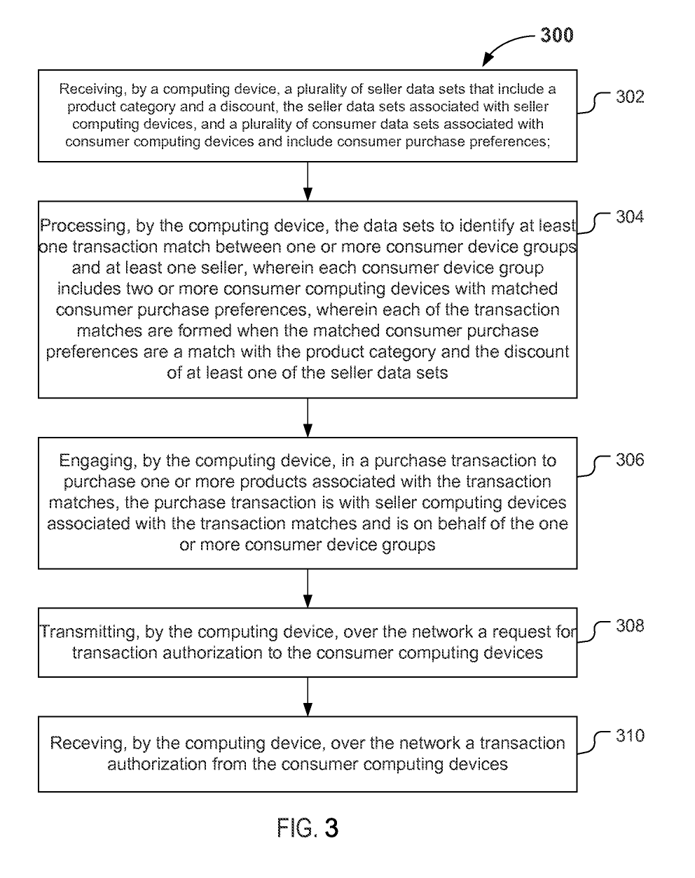

FIG. 3 schematically illustrates a method 300 for intermediating interactions between computing devices for an online purchase transaction, in accordance with some embodiments. In some embodiments, the method 300 may comprise receiving 302, by a computing device, a plurality of seller data sets that include a product category and a discount, the seller data sets associated with seller computing devices, and a plurality of consumer data sets associated with consumer computing devices and include consumer purchase preferences; processing 304, by the computing device, the data sets to identify at least one transaction match between one or more consumer device groups and at least one seller, wherein each consumer device group may include two or more consumer computing devices with matched consumer purchase preferences, wherein each of the transaction matches may be formed when the matched consumer purchase preferences may be a match with the product category and the discount of at least one of the seller data sets; and engaging 306, by the computing device, in a purchase transaction to purchase one or more products associated with the transaction matches, the purchase transaction may be with seller computing devices associated with the transaction matches and is on behalf of the one or more consumer device groups. In some embodiments, the consumer purchase preferences may include the product category, the discount, a purchase date, a seller, and a payment method, wherein the transaction matches may be identified when the product category matches and the discount matches between two or more consumer computing devices and at least one of the seller devices and the purchase date overlaps, the seller matches, and the payment method matches between the two or more consumer computing devices. In some embodiments, the method 300 may further comprise transmitting 308, by the computing device, over the network a request for transaction authorization to the consumer computing devices; and receiving 310, by the computing device, over the network a transaction authorization from the consumer computing devices.

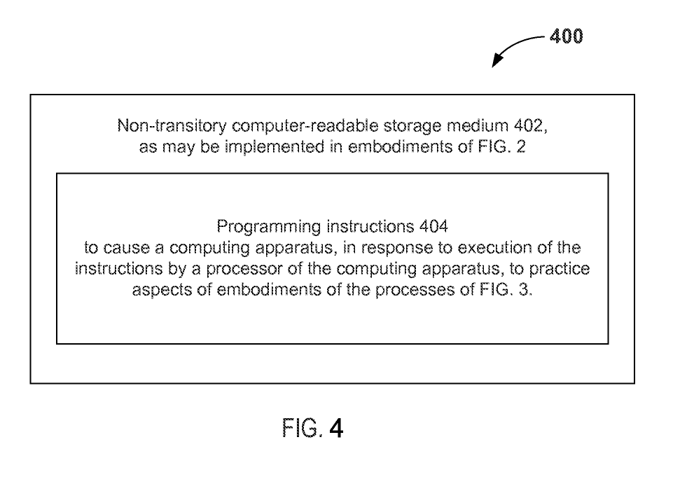

FIG. 4 schematically illustrates a non-transitory computer readable storage medium 402 with programming instructions 404 to cause a computing apparatus, in response to execution of the instructions by a processor of the computing apparatus, to practice aspects of embodiments of the processes for intermediating interactions between computing devices for an online purchase transaction as disclosed herein, in accordance with some embodiments 400. In some embodiments, the non-transitory computer readable storage medium (medium) 402 with the programming instructions 404 may be implemented in some embodiments of the computing apparatus 200 illustrated in FIG. 2 to practice aspects of the embodiments of the method 300 illustrated in FIG. 3, as further disclosed and described herein. In some embodiments, the programming instructions may cause the computing apparatus, to receive a plurality of seller data sets that include a product category and a discount, the seller data sets associated with seller computing devices, and a plurality of consumer data sets associated with consumer computing devices and include consumer purchase preferences; process the data sets to identify at least one transaction match between one or more consumer device groups and at least one seller, wherein each consumer device group may include two or more consumer computing devices with matched consumer purchase preferences, wherein each of the transaction matches may be formed when the matched consumer purchase preferences may be a match with the product category and the discount of at least one of the seller data sets; and engage in a purchase transaction to purchase one or more products associated with the transaction matches, the purchase transaction is with seller computing devices associated with the transaction matches and is on behalf of the one or more consumer device groups. In some embodiments, the consumer purchase preferences may include the product category, the discount, a purchase date, a seller, and a payment method, wherein the transaction matches may be identified when the product category matches and the discount matches between two or more consumer computing devices and at least one of the seller devices and the purchase date overlaps, the seller matches, and the payment method matches between the two or more consumer computing devices. In some embodiments, the programming instructions may cause the computing apparatus further to transmit over the network a request for transaction authorization to the consumer computing devices; and receive over the network a transaction authorization from the consumer computing devices.

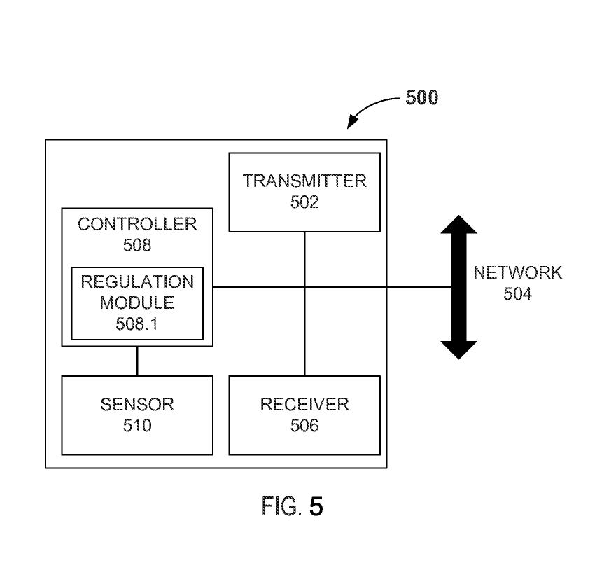

FIG. 5 schematically illustrates a computing apparatus 500 for intermediating interactions between computing devices for a purchase transaction, in accordance with some embodiments. In some embodiments, computing apparatus 500 may comprise a receiver 506 to receive over a network 504 a plurality of seller data sets that include a product category and a discount, the seller data sets associated with seller computing devices, and a plurality of consumer data sets associated with consumer computing devices and include consumer purchase preferences; a controller 508, coupled to the receiver 506, the controller 508 to process the data sets to identify at least one transaction match between one or more consumer device groups and at least one seller, wherein each consumer device group may include two or more consumer computing devices with matched consumer purchase preferences, wherein each of the transaction matches may be formed when the matched consumer purchase preferences may be a match with the product category and the discount of at least one of the seller data sets; and a transmitter 502, coupled to the controller 508, to transmit over the network 504 a request for transaction authorization to the one or more consumer device groups, wherein the receiver 506 may receive over the network a transaction authorization from the one or more consumer device groups. In some embodiments, the controller 508 may regulate the transmitter 502 to engage in a purchase transaction to purchase one or more products associated with the transaction matches, the purchase transaction is with the seller computing devices associated with the transaction matches and is on behalf of the one or more consumer device groups. In some embodiments, transmitter 502 may be coupled to a second computing apparatus, wherein the second computing apparatus may be coupled to the computing apparatus 500. In some embodiments, the consumer purchase preferences may include the product category, the discount, a purchase date, a seller, and a payment method, wherein the transaction matches may be identified when the product category matches and the discount matches among two or more consumer computing devices and at least one of the seller devices and the purchase date overlaps, the seller matches, and the payment method matches between the two or more consumer computing devices. In some embodiments, the controller 508 may associate the consumer data sets with consumer accounts, and the consumer accounts may include an account balance. In some embodiments, the controller 508 may place a hold of a hold amount on the account balance associated with one or more non-buyer consumer computing devices of the one or more consumer device groups, wherein the transmitter 502 may transmit the transaction authorization over the network 504 to the one or more consumer device groups, wherein the receiver 506 may receive over the network 504 a release of the hold amount from one or more buyer consumer computing devices of the one or more consumer device groups, wherein the controller 508 may remove the hold on the account balance associated with the one or more non-buyer consumer computing devices of the one or more consumer device groups.

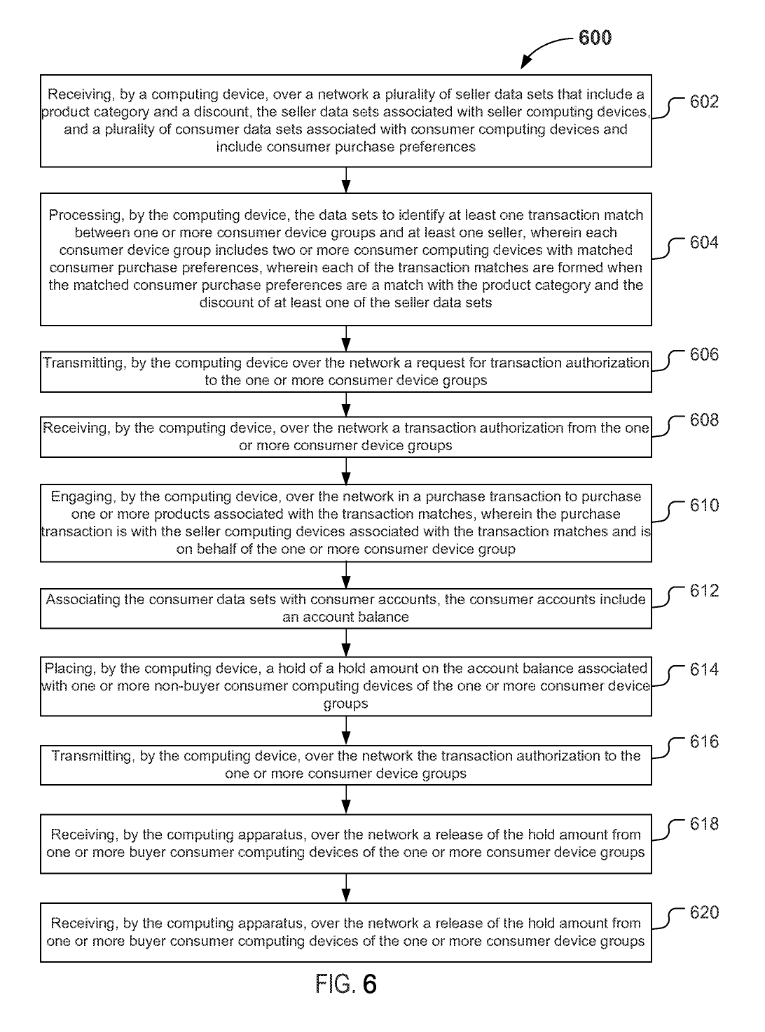

FIG. 6 schematically illustrates a method 600 for intermediating interactions between computing devices for a purchase transaction, in accordance with some embodiments. In some embodiments, the method 600 may comprise receiving 602, by a computing device, over a network a plurality of seller data sets that include a product category and a discount, the seller data sets associated with seller computing devices, and a plurality of consumer data sets associated with consumer computing devices and include consumer purchase preferences; processing 604, by the computing device, the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; transmitting 606, by the computing device over the network a request for transaction authorization to the one or more consumer device groups; and receiving 608, by the computing device, over the network a transaction authorization from the one or more consumer device groups. The method 600 may further comprise engaging 610, by the computing device, over the network in a purchase transaction to purchase one or more products associated with the transaction matches, wherein the purchase transaction may be with the seller computing devices associated with the transaction matches and may be on behalf of the one or more consumer device group. The method 600 may further comprise the consumer purchase preferences include the product category, the discount, a purchase date, a seller, and a payment method, wherein the transaction matches may be identified when the product category matches and the discount matches between two or more consumer computing devices and at least one of the seller devices and the purchase date overlaps, the seller matches, and the payment method matches between the two or more consumer computing devices. The method 600 may further comprise associating 612 the consumer data sets with consumer accounts, and the consumer accounts may include an account balance. The method 600 may further comprise placing 614, by the computing device, a hold of a hold amount on the account balance associated with one or more non-buyer consumer computing devices of the one or more consumer device groups; transmitting 616, by the computing device, over the network the transaction authorization to the one or more consumer device groups; receiving 618, by the computing apparatus, over the network a release of the hold amount from one or more buyer consumer computing devices of the one or more consumer device groups; and removing 620, by the computing apparatus, the hold of the hold amount on the account balance associated with the one or more non-buyer consumer computing devices of the one or more consumer device groups.

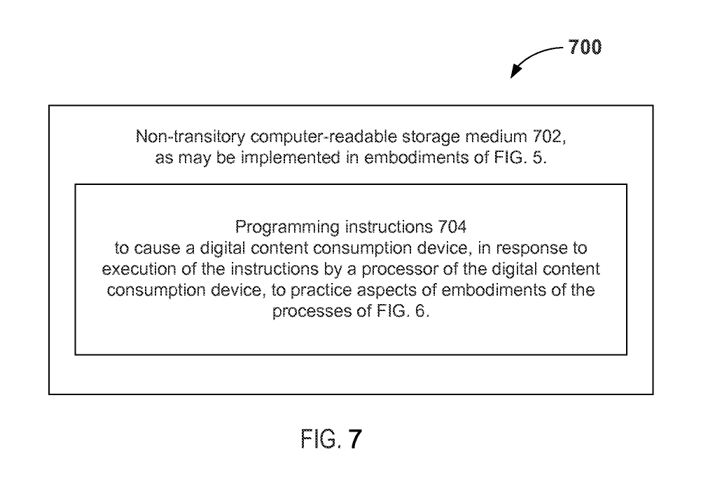

FIG. 7 schematically illustrates a non-transitory computer readable storage medium 702 with programming instructions 704 to cause a computing device, in response to execution of the instructions by a processor of the digital content consumption device, to practice aspects of embodiments of the processes for intermediating interactions between computing devices for a purchase transaction as disclosed herein, in accordance with some embodiments 700. In some embodiments, the non-transitory computer readable storage medium (medium) 702 with the programming instructions 704 may be implemented in some embodiments of the computing apparatus 500 illustrated in FIG. 5 to practice aspects of the embodiments of the method 600 illustrated in FIG. 6, as further disclosed and described herein. In some embodiments, the programming instructions may cause the computing apparatus to receive over a network a plurality of seller data sets that include a product category and a discount, the seller data sets associated with seller computing devices, and a plurality of consumer data sets associated with consumer computing devices and include consumer purchase preferences; process the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; transmit over the network a request for transaction authorization to the one or more consumer device groups; and receive over the network a transaction authorization from the one or more consumer device groups. In some embodiments, the programming instructions may cause the computing apparatus further to engage over the network in a purchase transaction to purchase one or more products associated with the transaction matches, wherein the purchase transaction may be with the seller computing devices associated with the transaction matches and may be on behalf of the one or more consumer device group. In some embodiments, the consumer purchase preferences may include the product category, the discount, a purchase date, a seller, and a payment method, wherein the transaction matches may be identified when the product category matches and the discount matches between two or more consumer computing devices and at least one of the seller devices and the purchase date overlaps, the seller matches, and the payment method matches between the two or more consumer computing devices. In some embodiments, the programming instructions may cause the computing apparatus further to associate the consumer data sets with consumer accounts, and the consumer accounts may include an account balance. In some embodiments, the programming instructions may cause the computing apparatus further to place a hold of a hold amount on the account balance associated with one or more non-buyer consumer computing devices of the one or more consumer device groups; transmit over the network the transaction authorization to the one or more consumer device groups; receive over the network a release of the hold amount from one or more buyer consumer computing devices of the one or more consumer device groups; and remove the hold of the hold amount on the account balance associated with the one or more non-buyer consumer computing devices of the one or more consumer device groups.

### Examples

According to various embodiments, the present disclosure describes a number of any of Examples.

Example 1 of a computing apparatus for intermediating interactions between computing devices may comprise: a receiver to receive over a network a plurality of seller data sets that include a product category and a discount, the seller data sets associated with seller computing devices, and a plurality of consumer data sets associated with consumer computing devices and include consumer purchase preferences; a controller, coupled to the receiver and a transmitter, the controller to process the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets, wherein the controller may regulate the transmitter to engage in a purchase transaction over the network to purchase one or more products associated with the transaction matches, the purchase transaction may be with the seller computing devices associated with the transaction matches and may be on behalf of the one or more consumer device groups.

Example 2 may include the apparatus of Example 1 and other examples herein, wherein the transmitter may be coupled to a second computing apparatus, wherein the second computing apparatus may be coupled to the computing apparatus.

Example 3 may include the apparatus of any of any of Examples 1-2 and other examples herein, wherein the consumer purchase preferences include the product category, the discount, a purchase date, a seller, and a payment method, wherein the transaction matches may be identified when the product category matches and the discount matches among two or more consumer computing devices and at least one of the seller devices and the purchase date overlaps, the seller matches, and the payment method matches between the two or more consumer computing devices.

Example 4 may include the apparatus of any of any of Examples 1-3 and other examples herein, wherein the controller may regulate the transmitter to transmit over the network a request for transaction authorization to the consumer computing devices and to regulate the receiver to receive over the network a transaction authorization from the consumer computing devices.

Example 5 of a computing apparatus for intermediating interactions between computing devices may comprise: a receiver to receive over a network a plurality of seller data sets that include a product category and a discount, the seller data sets associated with seller computing devices, and a plurality of consumer data sets associated with consumer computing devices and include consumer purchase preferences; a controller, coupled to the receiver, the controller to process the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; and a transmitter, coupled to the controller, to transmit over the network a request for transaction authorization to the one or more consumer device groups, wherein the receiver may receive over the network a transaction authorization from the one or more consumer device groups.

Example 6 may include the apparatus of Example 5 and other examples herein, wherein the controller may regulate the transmitter to engage in a purchase transaction to purchase one or more products associated with the transaction matches, the purchase transaction may be with the seller computing devices associated with the transaction matches and may be on behalf of the one or more consumer device groups.

Example 7 may include the apparatus of any of any of Examples 5-7 and other examples herein, wherein the transmitter may be coupled to a second computing apparatus, wherein the second computing apparatus may be coupled to the computing apparatus.

Example 8 may include the apparatus of any of any of Examples 5-7 and other examples herein, wherein the consumer purchase preferences include the product category, the discount, a purchase date, a seller, and a payment method, wherein the transaction matches may be identified when the product category matches and the discount matches among two or more consumer computing devices and at least one of the seller devices and the purchase date overlaps, the seller matches, and the payment method matches between the two or more consumer computing devices.

Example 9 may include the apparatus of any of any of Examples 5-8 and other examples herein, wherein the controller may associate the consumer data sets with consumer accounts, the consumer accounts include an account balance.

Example 10 may include the apparatus of any of any of Examples 5-9 and other examples herein, wherein the controller may place a hold of a hold amount on the account balance associated with one or more non-buyer consumer computing devices of the one or more consumer device groups, wherein the transmitter may transmit the transaction authorization over the network to the one or more consumer device groups, wherein the receiver may receive over the network a release of the hold amount from one or more buyer consumer computing devices of the one or more consumer device groups, wherein the controller may remove the hold on the account balance associated with the one or more non-buyer consumer computing devices of the one or more consumer device groups.

Example 11 of a method for intermediating interactions between computing devices may comprise: receiving, by a computing device, a plurality of seller data sets that include a product category and a discount, the seller data sets associated with seller computing devices, and a plurality of consumer data sets associated with consumer computing devices and include consumer purchase preferences; processing, by the computing device, the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; and engaging, by the computing device, in a purchase transaction to purchase one or more products associated with the transaction matches, the purchase transaction may be with seller computing devices associated with the transaction matches and may be on behalf of the one or more consumer device groups.

Example 12 may include the method of Example 11 and other examples herein, wherein the consumer purchase preferences include the product category, the discount, a purchase date, a seller, and a payment method, wherein the transaction matches may be identified when the product category matches and the discount matches between two or more consumer computing devices and at least one of the seller devices and the purchase date overlaps, the seller matches, and the payment method matches between the two or more consumer computing devices.

Example 13 may include the method of any of any of Examples 11-12 and other examples herein, further comprising: transmitting, by the computing device, over the network a request for transaction authorization to the consumer computing devices; and receiving, by the computing device, over the network a transaction authorization from the consumer computing devices.

Example 14 of a method for intermediating interactions between computing devices may comprise: receiving, by a computing device, over a network a plurality of seller data sets that include a product category and a discount, the seller data sets associated with seller computing devices, and a plurality of consumer data sets associated with consumer computing devices and include consumer purchase preferences; processing, by the computing device, the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; transmitting, by the computing device, over the network a request for transaction authorization to the one or more consumer device groups; and receiving, by the computing device, over the network a transaction authorization from the one or more consumer device groups.

Example 15 may include the method of Example 14 and other examples herein, further comprising: engaging, by the computing device, over the network in a purchase transaction to purchase one or more products associated with the transaction matches, wherein the purchase transaction may be with the seller computing devices associated with the transaction matches and may be on behalf of the one or more consumer device group.

Example 16 may include the method of any of any of Examples 14-15 and other examples herein, wherein the consumer purchase preferences include the product category, the discount, a purchase date, a seller, and a payment method, wherein the transaction matches may be identified when the product category matches and the discount matches between two or more consumer computing devices and at least one of the seller devices and the purchase date overlaps, the seller matches, and the payment method matches between the two or more consumer computing devices.

Example 17 may include the method of any of Examples 14-16 and other examples herein, further comprising: associating the consumer data sets with consumer accounts, the consumer accounts include an account balance.

Example 18 may include the method of Example 14-17 and other examples herein, further comprising: placing, by the computing device, a hold of a hold amount on the account balance associated with one or more non-buyer consumer computing devices of the one or more consumer device groups; transmitting, by the computing device, over the network the transaction authorization to the one or more consumer device groups; receiving, by the computing device, over the network a release of the hold amount from one or more buyer consumer computing devices of the one or more consumer device groups; and removing, by the computing device, the hold of the hold amount on the account balance associated with the one or more non-buyer consumer computing devices of the one or more consumer device groups.

Example 19 of a computing apparatus for intermediating interactions between computing devices may comprise: receive means for receiving over a network a plurality of seller data sets that include a product category and a discount, the seller data sets associated with seller computing devices, and a plurality of consumer data sets associated with consumer computing devices and include consumer purchase preferences; process means for processing the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; engage means for engaging in a purchase transaction over the network to purchase one or more products associated with the transaction matches, wherein the purchase transaction may be with the seller computing devices associated with the transaction matches and may be on behalf of the one or more consumer device groups.

Example 20 may include the apparatus of Example 19 and other examples herein, wherein the consumer purchase preferences include the product category, the discount, a purchase date, a seller, and a payment method, wherein the transaction matches may be identified when the product category matches and the discount matches among two or more consumer computing devices and at least one of the seller devices and the purchase date overlaps, the seller matches, and the payment method matches between the two or more consumer computing devices.

Example 21 may include the apparatus of any of Examples 19-20 and other examples herein, further comprising: transmit means for transmitting over the network a request for transaction authorization to the consumer computing devices; and receive means for receiving over the network a transaction authorization from the consumer computing devices.

Example 22 of a computing apparatus for intermediating interactions between computing devices may comprise: receive means for receiving over a network a plurality of seller data sets that include a product category and a discount, the seller data sets associated with seller computing devices, and a plurality of consumer data sets associated with consumer computing devices and include consumer purchase preferences; process means for processing the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; transmit means for transmitting over the network a request for transaction authorization to the one or more consumer device groups; and receive means for receiving over the network a transaction authorization from the one or more consumer device groups.

Example 23 may include the apparatus of Example 22 and other examples herein, further comprising: engage means for engaging in a purchase transaction to purchase one or more products associated with the transaction matches, the purchase transaction may be with the seller computing devices associated with the transaction matches and may be on behalf of the one or more consumer device groups.

Example 24 may include the apparatus of any of Examples 22-23 and other examples herein, wherein the consumer purchase preferences include the product category, the discount, a purchase date, a seller, and a payment method, wherein the transaction matches may be identified when the product category matches and the discount matches among two or more consumer computing devices and at least one of the seller devices and the purchase date overlaps, the seller matches, and the payment method matches between the two or more consumer computing devices.

Example 25 may include the apparatus of any of Examples 22-24 and other examples herein, further comprising: associate means for associating the consumer data sets with consumer accounts, the consumer accounts include an account balance.

Example 26 may include the apparatus of any of Examples 22-25 and other examples herein, further comprising: place means for placing a hold of a hold amount on the account balance associated with one or more non-buyer consumer computing devices of the one or more consumer device groups; transmit means for transmitting the transaction authorization over the network to the one or more consumer device groups; receive means for receiving over the network a release of the hold amount from one or more buyer consumer computing devices of the one or more consumer device groups; and remove means for removing the hold on the account balance associated with the one or more non-buyer consumer computing devices of the one or more consumer device groups.

Example 27 may comprise one or more non-transitory computer readable media comprising instructions to cause a computing apparatus for intermediating interactions between computing devices, in response to execution of the instructions by a processor of the computing apparatus, to: receive over a network a plurality of seller data sets that include a product category and a discount, the seller data sets associated with seller computing devices, and a plurality of consumer data sets associated with consumer computing devices and include consumer purchase preferences; process the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; and engage in a purchase transaction to purchase one or more products associated with the transaction matches, the purchase transaction may be with seller computing devices associated with the transaction matches and may be on behalf of the one or more consumer device groups.

Example 28 may include the one or more non-transitory computer readable media of Example 27 and other examples herein, wherein the consumer purchase preferences include the product category, the discount, a purchase date, a seller, and a payment method, wherein the transaction matches may be identified when the product category matches and the discount matches between two or more consumer computing devices and at least one of the seller devices and the purchase date overlaps, the seller matches, and the payment method matches between the two or more consumer computing devices.

Example 29 may include the one or more non-transitory computer readable media of any of Examples 27-28 and other examples herein, further comprising: transmit over the network a request for transaction authorization to the consumer computing devices; and receive over the network a transaction authorization from the consumer computing devices.

Example 30 may comprise one or more non-transitory computer readable media comprising instructions to cause a computing apparatus for intermediating interactions between computing devices, in response to execution of the instructions by a processor of the computing apparatus, to: receive over a network a plurality of seller data sets that include a product category and a discount, the seller data sets associated with seller computing devices, and a plurality of consumer data sets associated with consumer computing devices and include consumer purchase preferences; process the data sets to identify at least one transaction match between one or more consumer device groups and at least one seller, wherein each consumer device group includes two or more consumer computing devices with matched consumer purchase preferences, wherein each of the transaction matches may be formed when the matched consumer purchase preferences may be a match with the product category and the discount of at least one of the seller data sets; transmit over the network a request for transaction authorization to the one or more consumer device groups; and receive over the network a transaction authorization from the one or more consumer device groups.

Example 31 may include the one or more non-transitory computer readable media of Example 30 and other examples herein, further comprising: engage over the network in a purchase transaction to purchase one or more products associated with the transaction matches, wherein the purchase transaction may be with the seller computing devices associated with the transaction matches and may be on behalf of the one or more consumer device group.

Example 32 may include the one or more non-transitory computer readable media of any of Examples 30-31 and other examples herein, wherein the consumer purchase preferences include the product category, the discount, a purchase date, a seller, and a payment method, wherein the transaction matches may be identified when the product category matches and the discount matches between two or more consumer computing devices and at least one of the seller devices and the purchase date overlaps, the seller matches, and the payment method matches between the two or more consumer computing devices.

Example 33 may include the one or more non-transitory computer readable media of any of Examples 30-32 and other examples herein, further comprising: associate the consumer data sets with consumer accounts, the consumer accounts include an account balance.

Example 34 may include the one or more non-transitory computer readable media of any of Examples 30-33 and other examples herein, further comprising: place a hold of a hold amount on the account balance associated with one or more non-buyer consumer computing devices of the one or more consumer device groups; transmit over the network the transaction authorization to the one or more consumer device groups; receive over the network a release of the hold amount from one or more buyer consumer computing devices of the one or more consumer device groups; and remove the hold of the hold amount on the account balance associated with the one or more non-buyer consumer computing devices of the one or more consumer device groups.

What is claimed is:

1. A computing apparatus for intermediating interactions between computing devices, comprising:
a receiver to receive over a network a plurality of seller data sets that include a product category and a discount, the seller data sets associated with seller computing devices, and a plurality of consumer data sets associated with consumer computing devices and include consumer purchase preferences;
a controller, coupled to the receiver and a transmitter, the controller to process the data sets to identify at least one transaction match between one or more consumer device groups and at least one seller, wherein each consumer device group includes two or more consumer computing devices with matched consumer purchase preferences, wherein each of the transaction matches are formed when the matched consumer purchase preferences are a match with the product category and the discount of at least one of the seller data sets, wherein the controller is to regulate the transmitter to engage in a purchase transaction over the network to purchase one or more products associated with the transaction matches, the purchase transaction is with the seller computing devices associated with the transaction matches and is on behalf of the one or more consumer device groups.

2. The apparatus of claim 1, wherein the transmitter is coupled to a second computing apparatus, wherein the second computing apparatus is coupled to the computing apparatus.

3. The apparatus of claim 1, wherein the consumer purchase preferences include the product category, the discount, a purchase date, a seller, and a payment method, wherein the transaction matches are identified when the product category matches and the discount matches among two or more consumer computing devices and at least one of the seller devices and the purchase date overlaps, the seller matches, and the payment method matches between the two or more consumer computing devices.

4. The apparatus of claim 1, wherein the controller is to regulate the transmitter to transmit over the network a request for transaction authorization to the consumer computing devices and to regulate the receiver to receive over the network a transaction authorization from the consumer computing devices.

5. A computing apparatus for intermediating interactions between computing devices, comprising:
a receiver to receive over a network a plurality of seller data sets that include a product category and a discount, the seller data sets associated with seller computing devices, and a plurality of consumer data sets associated with consumer computing devices and include consumer purchase preferences;
a controller, coupled to the receiver, the controller to process the data sets to identify at least one transaction match between one or more consumer device groups and at least one seller, wherein each consumer device group includes two or more consumer computing devices with matched consumer purchase preferences, wherein each of the transaction matches are formed when the matched consumer purchase preferences are a match with the product category and the discount of at least one of the seller data sets; and
a transmitter, coupled to the controller, to transmit over the network a request for transaction authorization to the one or more consumer device groups, wherein the receiver is to receive over the network a transaction authorization from the one or more consumer device groups.

6. The apparatus of claim 5, wherein the controller is to regulate the transmitter to engage in a purchase transaction to purchase one or more products associated with the transaction matches, the purchase transaction is with the seller computing devices associated with the transaction matches and is on behalf of the one or more consumer device groups.

7. The apparatus of claim 6, wherein the transmitter is coupled to a second computing apparatus, wherein the second computing apparatus is coupled to the computing apparatus.

8. The apparatus of claim 5, wherein the consumer purchase preferences include the product category, the discount, a purchase date, a seller, and a payment method, wherein the transaction matches are identified when the product category matches and the discount matches among two or more consumer computing devices and at least one of the seller devices and the purchase date overlaps, the seller matches, and the payment method matches between the two or more consumer computing devices.

9. The apparatus of claim 5, wherein the controller is to associate the consumer data sets with consumer accounts, the consumer accounts include an account balance.

10. The apparatus of claim 9, wherein the controller is to place a hold of a hold amount on the account balance associated with one or more non-buyer consumer computing devices of the one or more consumer device groups, wherein the transmitter is to transmit the transaction authorization over the network to the one or more consumer device groups, wherein the receiver is to receive over the network a release of the hold amount from one or more buyer consumer computing devices of the one or more consumer device groups, wherein the controller is to remove the hold on the account balance associated with the one or more non-buyer consumer computing devices of the one or more consumer device groups.

11. A method for intermediating interactions between computing devices, comprising:
receiving, by a computing device, a plurality of seller data sets that include a product category and a discount, the seller data sets associated with seller computing devices, and a plurality of consumer data sets associated with consumer computing devices and include consumer purchase preferences;
processing, by the computing device, the data sets to identify at least one transaction match between one or more consumer device groups and at least one seller, wherein each consumer device group includes two or more consumer computing devices with matched consumer purchase preferences, wherein each of the transaction matches are formed when the matched consumer purchase preferences are a match with the product category and the discount of at least one of the seller data sets; and
engaging, by the computing device, in a purchase transaction to purchase one or more products associated with the transaction matches, the purchase transaction is with seller computing devices associated with the transaction matches and is on behalf of the one or more consumer device groups.

12. The method of claim 11, wherein the consumer purchase preferences include the product category, the discount, a purchase date, a seller, and a payment method, wherein the transaction matches are identified when the product category matches and the discount matches between two or more consumer computing devices and at least one of the seller devices and the purchase date overlaps, the seller matches, and the payment method matches between the two or more consumer computing devices.

13. The method of claim 11, further comprising:
transmitting, by the computing device, over the network a request for transaction authorization to the consumer computing devices; and
receiving, by the computing device, over the network a transaction authorization from the consumer computing devices.

14. A method for intermediating interactions between computing devices, comprising:
receiving, by a computing device, over a network a plurality of seller data sets that include a product category and a discount, the seller data sets associated with seller computing devices, and a plurality of consumer data sets associated with consumer computing devices and include consumer purchase preferences;
processing, by the computing device, the data sets to identify at least one transaction match between one or more consumer device groups and at least one seller, wherein each consumer device group includes two or more consumer computing devices with matched consumer purchase preferences, wherein each of the transaction matches are formed when the matched consumer purchase preferences are a match with the product category and the discount of at least one of the seller data sets;
transmitting, by the computing device, over the network a request for transaction authorization to the one or more consumer device groups; and
receiving, by the computing device, over the network a transaction authorization from the one or more consumer device groups.

15. The method of claim 14, further comprising:
engaging, by the computing device, over the network in a purchase transaction to purchase one or more products associated with the transaction matches, wherein the purchase transaction is with the seller computing devices associated with the transaction matches and is on behalf of the one or more consumer device group.

16. The method of claim 14, wherein the consumer purchase preferences include the product category, the discount, a purchase date, a seller, and a payment method, wherein the transaction matches are identified when the product category matches and the discount matches between two or more consumer computing devices and at least one of the seller devices and the purchase date overlaps, the seller matches, and the payment method matches between the two or more consumer computing devices.

17. The method of claim 14, further comprising:
associating the consumer data sets with consumer accounts, the consumer accounts include an account balance.

18. The method of claim 17, further comprising:
placing, by the computing device, a hold of a hold amount on the account balance associated with one or more non-buyer consumer computing devices of the one or more consumer device groups;
transmitting, by the computing device, over the network the transaction authorization to the one or more consumer device groups;
receiving, by the computing device, over the network a release of the hold amount from one or more buyer consumer computing devices of the one or more consumer device groups; and
removing, by the computing device, the hold of the hold amount on the account balance associated with the one or more non-buyer consumer computing devices of the one or more consumer device groups.
